(19) United States
(12) Patent Application Publication
(10) Pub. No.: US 2017/0302433 A1
(43) Pub. Date: Oct. 19, 2017

(54) Method And Apparatus For Time Transport In A Communication Network

(71) Applicant: William E Powell, Cary, NC (US)

(72) Inventor: William E Powell, Cary, NC (US)

(73) Assignee: Alcatel-Lucent USA Inc., Murray Hill, NJ (US)

(21) Appl. No.: 15/155,914

(22) Filed: May 16, 2016

Related U.S. Application Data
(60) Provisional application No. 62/162,077, filed on May 15, 2015.

(51) Int. Cl. H04L 7/00; H04L 5/00; H04B 10/27; H04L 12/26; H04B 10/25

(52) U.S. Cl. CPC H04L 7/0075; H04L 43/0805; H04B 10/2504; H04B 10/27; H04L 5/0007

(57) ABSTRACT

A method and apparatus for synchronizing nodes in a communication network. A such as an EPoC, PON, or EPoC/PON hybrid access network. The network node receives or originates a ToD value and calculates future ToD value for a second node, which the first node includes in a ToD message for sending to the second node. The ToD message preferably includes a correction based on an OFDM ranging delay value and an adjustment based on a total transmit/receive PHY path asymmetry value with respect to the two nodes. A similar future ToD message is preferably sent to each downstream node that the first node is serving.

### CROSS-REFERENCE TO RELATED APPLICATIONS

This non-provisional disclosure is related to and claims priority from U.S. Provisional Patent Application Ser. No. 61/162,077, entitled Time Transport in a Communication Network and filed on 15 May 2015, the entire contents of which are incorporated by reference herein.

### BACKGROUND

### Field of the Disclosure

The present disclosure relates generally to the field of communication networks, and, more particularly, to a method and apparatus for improving time transport and synchronization in a communication network node, for example an access network implemented in optical fiber or coaxial cable, or both.

### Description of the Related Art

The following abbreviations are herewith expanded, at least some of which are referred to within the following description.

CLT Coaxial Line Terminal

CNU Coaxial Network Unit

EPoC EPON over Coax

EPON Ethernet PON

FCU Fiber-Coax Unit

FDD Frequency Division Duplexing

HFC Hybrid Fiber/Coax

IEEE Institute of Electrical and Electronics Engineers

MAC Media Access Control

MBH Mobile Backhaul

MPCP Multi-Point Control Protocol

OFDM Orthogonal Frequency Division Multiplexing

OLT Optical Line Terminal

ONU Optical Network Unit

PLC PHY Link Channel

PMD Physical Media Dependent [layer]

PON Passive Optical Network

TDD Time Division Duplexing

ToD Time of Day

TQ Time Quanta

TS TimeStamp

ONU Optical Network Unit

PLC PHY Link Channel

PON Passive Optical Network

PMD Physical Media Development

TDD Time Division Duplexing

TQ Time Quanta

TS Time Stamp

Communication networks in general provide the ability for one network or network node to communicate with others. An access network, for example, provides a connection between a large network such as the Internet or one belonging to a service provider to communicate with individual subscribers. One such network is a PON (passive optical network) that uses optical fiber for communication from a central office. Other access network use coax cables for a similar purpose. Hybrid networks exist wherein optical fibers from a central office are connected with coax cables, often at a distribution point to which the coax cables are already connected.

Such networks usually operate according to standard protocols that permit interaction between multiple nodes, including various nodes made by different manufacturers. One such protocol is generally known as Ethernet, which has been promulgated in the form of a number of separate publications.

Ethernet provides a manner for time-synchronizing network nodes for efficient operation. In one scheme, a time value often referred to as ToD (time of day) is sent, usually from an upstream node toward one or more downstream nodes located at subscribers' premises or at some intermediate location. As transmitting such a value itself involves some delay, the ToD is often expressed a future clock value to be reached at some point in time that is determinable by the downstream node. There exists a need for improved ways of doing this, however, for providing better quality of service.

Note that the techniques or schemes described herein as existing or possible are presented as background for the present invention, but no admission is made thereby that these techniques and schemes were heretofore commercialized or known to others besides the inventors.

### SUMMARY OF EMBODIMENTS

Following is a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one aspect, disclosed is a method of facilitating synchronization of nodes in a communication network including performing OFDM ranging by the first node to determine an OFDM ranging delay value for transmissions between the first node and the second node, receiving a ToD value at the first node, and calculating by the first node a future ToD value for the second node based on at least the received ToD value and a ToD correction value based at least on the determined OFDM ranging delay value. A future ToD message based at least in part on the future ToD value and the ToD correction value may be generated and transmitted toward the second node. The future ToD message may include the calculated future ToD value and the ToD correction value, or simply in clued a corrected future ToD value, or both.

The method may further include determining an MPCP ranging delay value for transmissions between the first node and the second node and storing the MPCP ranging delay value in a memory device. In this case, the ToD correction value is based at least in part on the MPCP ranging delay value, for example a ToD correction value is based at least in part on the difference between the MPCP ranging delay value and the OFDM ranging delay value.

The method may further include determining a total transmit/receive PHY path asymmetry value with respect to the first node and the second node and using this value to adjust either the OFDM ranging delay value or the MPCP ranging delay value. or both, based at least in part on the total transmit/receive PHY path asymmetry value.

In another aspect, an apparatus is disclosed for performing the operations described above and in the detailed description that follows.

In another aspect, disclosed is an apparatus that is a machine-readable storage medium embodying program instructions that when executed by one or more processors cause a first network node to perform OFDM ranging to determine an OFDM ranging delay value for transmissions between the first node and a second node, receive a ToD value at the first node, and calculating by the first node a future ToD value for the second node based on at least the received ToD value and a ToD correction value based at least on the determined OFDM ranging delay value.

The machine-readable storage medium may also embody program instructions that when executed further cause the network node to generate a future ToD message based at least in part on the future ToD value and the ToD correction value. In some embodiments, the program instructions when executed further cause the network node to determine an MPCP ranging delay value for transmissions between the first node and the second node, and wherein the ToD correction value is based at least in part on the MPCP ranging delay value. The program instructions when executed may further cause the network node to determine a total transmit/receive PHY path asymmetry value with respect to the first node and the second node and to adjust the OFDM ranging value based at least in part on the total transmit/receive PHY path asymmetry value.

Additional aspects will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a simplified block diagram illustrating an exemplary passive optical network.

FIG. 2 is a simplified block diagram illustrating selected components of a access network according to one embodiment

FIG. 3 is a simplified block diagram illustrating selected components of an access network according to one embodiment.

FIG. 4 is a simplified block diagram illustrating selected components of an access-network CLT and a CNU such as the CLT and CNU shown in FIG. 3 according to one embodiment.

FIG. 5 is a flow diagram illustrating a method according to one embodiment.

### DETAILED DESCRIPTION

The present disclosure is directed relates to time transport, that is, reliably transporting a ToD (time-of-day) value to a remote network node so that it can synchronize clocks with other nodes. This process of course may be frustrated by delays in transmission. As mentioned above, it is inadequate or at least undesirable to simply maintain a clock within each node. The solution presented here is especial advantageous in access networks having an EPoC (Ethernet PON over Coax) component.

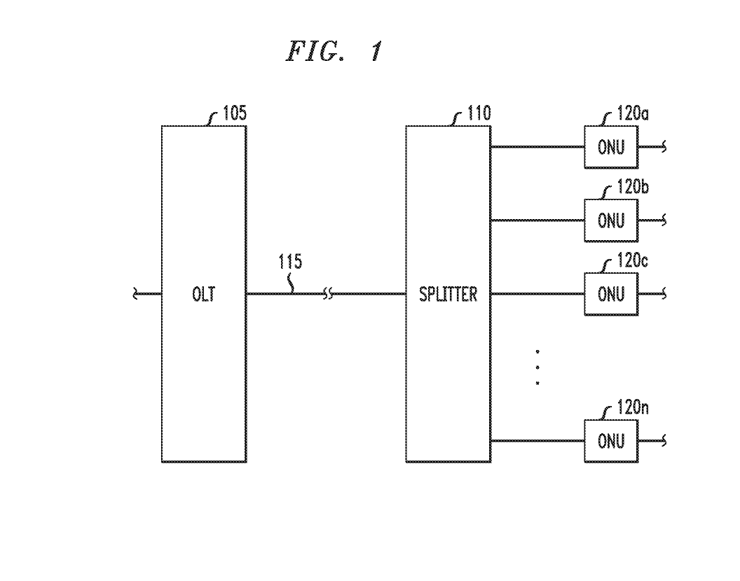

FIG. 1 is a simplified block diagram illustrating an exemplary passive optical network 100. Network 100 as shown here includes an OLT 105, often located in a service-provider central office, and a number of ONUs 120a through 120n. Optical transmissions, both upstream and downstream, traverse a feeder fiber 115 between OLT 105 and an optical splitter 110, which may be located in what is often referred to an outside plant. A number of access fibers 125a through 125n handle the transmissions between the splitter 110 and each individual ONU 120. While in some implementations, each ONU may be located at a subscriber premises, but may also form all or part of an interface with a non-fiber portion (not shown in FIG. 1) of an access network.

In operation, The OLT 105 of network transmits downstream signals that are distributed to each ONU 120 by the optical splitter 110. Each ONU 120 may then extract its own portion of the downstream transmission and discard the remainder (although the extraction may be done by other components as well). Upstream transmissions from each ONU 120 to OLT 105 traverse the same path, and are often at a different wavelength so as not to interfere with downstream transmissions. In addition, upstream transmissions from different ONUs are typically scheduled by the OLT 105 so as not to interfere with each other.

Clock synchronization between nodes is, of course, important for maintaining such schedules, and in implementation the usual practice is to synchronize each ONU with the OLT. This may be done, for example, according to the IEEE-1588v2 packet-based precision time protocol. In this case the OLT may itself receive ToD (time of day) input from an external source, upon which an MPCP (multi-point control protocol) TQ (time quanta) counter is timed.

Time-stamped MPCP messages are then sent from the OLT 105 to each ONU 125, where they are used to maintain an ONU MPCP counter (not shown in FIG. 1). The ONU MPCP counter then returns time-stamped messages of its own to the ONT 105. The OLT ToD and Logic unit 206 can then compare OLT timestamps to ONU timestamps and calculate an RTT (round trip time) between the two nodes. From the data it receives or calculates, ToD and Logic unit 206 may also calculate a future ToD applicable in the ONU at a future time certain. Preferably, The OLT 105 then sends a ToD correction message including the future ToD and perhaps other information, for example according to the IEEE802.1 as protocol, to ONU 120. ONU ToD logic then determines an ONU ToD and may in some cases pass this ONU ToD downstream for use by other components, for example in an EPoC hybrid access network.

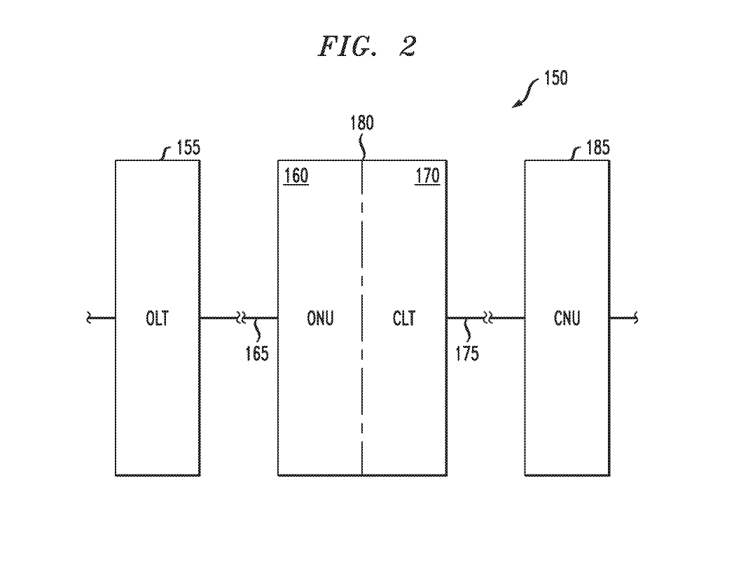

FIG. 2 is a simplified block diagram illustrating selected components of a typical access network 150. In this example, access network 150 includes an OLT 155 and an ONU 160 in communication via an optical fiber 165. ONU 160 is collocated with a CLT 170 in an ONU/CLT node 180. Being co-resident in ONU/CLT node 180, ONU 160 and CLT 170 may share some computing and memory facilities, and a path of communication between them is presumed. CLT 170 is also in communication with CNU 185 via a coax cable 175. This configuration may be useful to form an access network where coax cables to, for example, subscriber premises already exist. Note that although only one of each node/component is shown in FIG. 2, in a given implementation there may be more of some or all of them.

Time transport or synchronization in this embodiment may proceed substantially as described above in reference to FIG. 1, with the process executing between OLT 155 and ONU 160 essentially being repeating between CLT 170 and CNU 185. This has its disadvantages, however; simply reusing the 802.1 as protocol using and exchange of MPCP may in effect double the time transport error introduced in the OLT-ONU portion of network 150. A new and expectedly less troublesome time transport mechanism is therefore proposed herein.

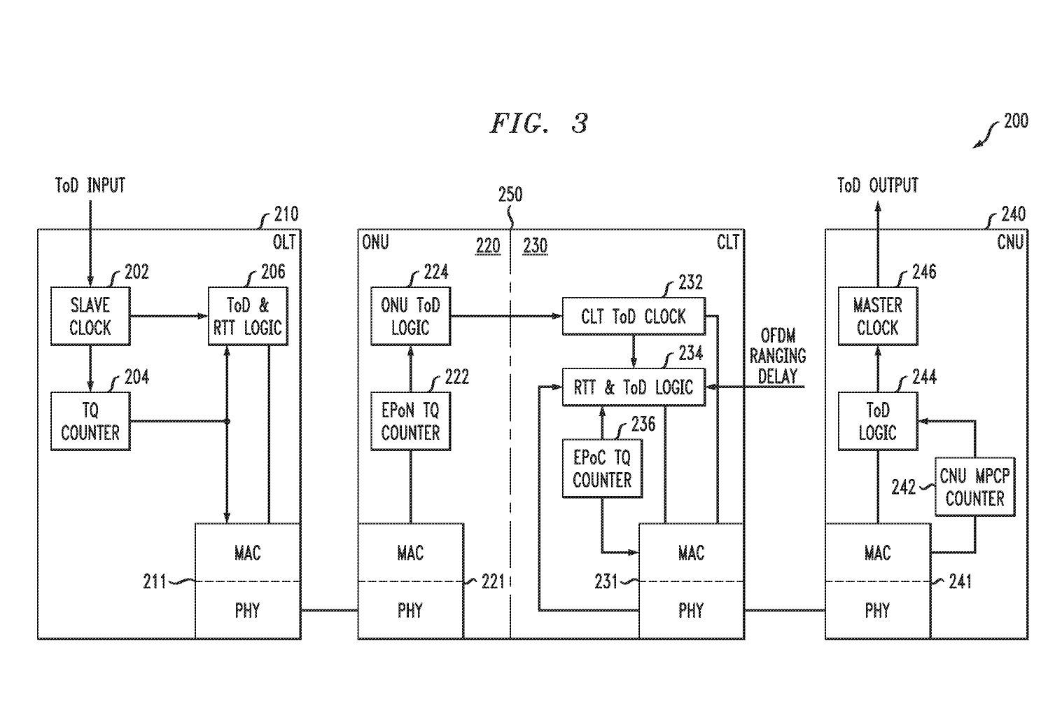

FIG. 3 is a simplified block diagram illustrating selected components of an access network 200 according to one embodiment. An EPON (Ethernet PON) portion of the access network 200 includes an OLT 210 and an ONU 220, which components may operate similarly if not identically as described above in related to FIG. 1. An EPoC portion of the network 200 includes a CLT 230 and a CNU 240. In the embodiment of FIG. 3, The ONU 220 and the CLT 230 are combined as a single component, referred to herein as ONU/CLT 250, as may be the case in some implementations. Note again that while only one of each component is illustrated in FIG. 3, there may more. The mechanism described herein in relation to the CLT and a representative CNU is simply replicated for each additional pair that are actually implemented. (The values for each CNU are independent, however, so while it is preferred that the process be performed for each pair in the access network, this is not a requirement unless specifically recited.)

Each of the components of access network 200 includes a network interface, as shown in FIG. 3. Network interface 211 is associated with OLT 210 and network interface 221 is associated with ONU 220. Similarly, network interface 231 is associated with CLT 230 and network interface 241 is associated with CNU 240. Each of the network interfaces includes a MAC (media access control) layer and a PHY (physical) layer, though with most of the communications discussed herein will in this embodiment pass. Other interfaces (not shown) may be present as well, such as one for the OLT 210 to interact with other components in the central office, and one for each CNU to communicate with, for example, a subscriber network.

In this embodiment, OLT 210 also includes a slave clock 202 that is maintained by ToD input from outside the OLT 210. The input may, for example, be formatted in packets according to IEEE 1522v2. The clock provides a local ToD to ToD and RTT logic unit 206 and to a TQ counter 204, which in turn provides output to the ToD and RTT logic unit 206 and to the MAC layer of network interface 211.

In operation, in this embodiment the OLT TQ counter 204 provides timestamped MPCP packets to ONU 220, and specifically to EPON TQ counter 222. The EPON TQ counter 222 of ONU 220 in turn provides to timestamped MPCP packets to the ToD and RTT logic unit 206 of OLT 210. ToD and RTT logic unit 206 calculates the RTT and provides a future ToD and perhaps other correction factors to the ONU 220, for example according to IEEE 802.1 as, as alluded to above.

In the embodiment of FIG. 3, the correction message is provided to ONU ToD logic unit 224, which determines an ONU ToD and provides it to CLT clock generator 232. In this embodiment, ONU 220 and CLT 230 are co-located, and may even share processing and memory facilities (not shown), although this will not be true in all embodiments. For example, ONU 220 and CLT 230 could in another embodiment be separate units and communicate with each other via an optical fiber between network interface 221 and network interface 231. Note that provision of a ToD value from ONU 220 to CLT 230 may be affected by their manner of communication. Note also that in some embodiments, the ToD input for CLT 230 may arrive from a different source.

In the embodiment of FIG. 3, the CLT clock generator 232 generates reference clocks to the CLT RTT and ToD logic unit 234 and to the CLT MPCP counter 236. The CLT MPCP counter 236 provides input to the to the CLT network interface 231 MAC layer and to the CLT RTT and ToD logic unit 234. It also provides timestamped MPCP packets to the CNU MPCP counter 242 of CNU 240. The CNU MPCP counter 242 returns its own timestamped MPCP packets to the RTT and Logic unit 234 of CLT 230.

The RTT & Logic unit 234, which also receives a value for OFDM ranging delay, described below, calculates a future ToD applicable in the CNU 240 at a future time certain. Preferably, the CLT 250 then sends a ToD correction message including the future ToD and perhaps other information to CNU 240. CNU 240 receives this correction message at CNU ToD logic unit 244 and determines a CNU ToD. In this embodiment, ToD logic unit 244 provides this CNT ToD to a CNU master clock 246. CNU master clock 246 may then provide the ToD to other components as well, for example to a router in a home network (not shown).

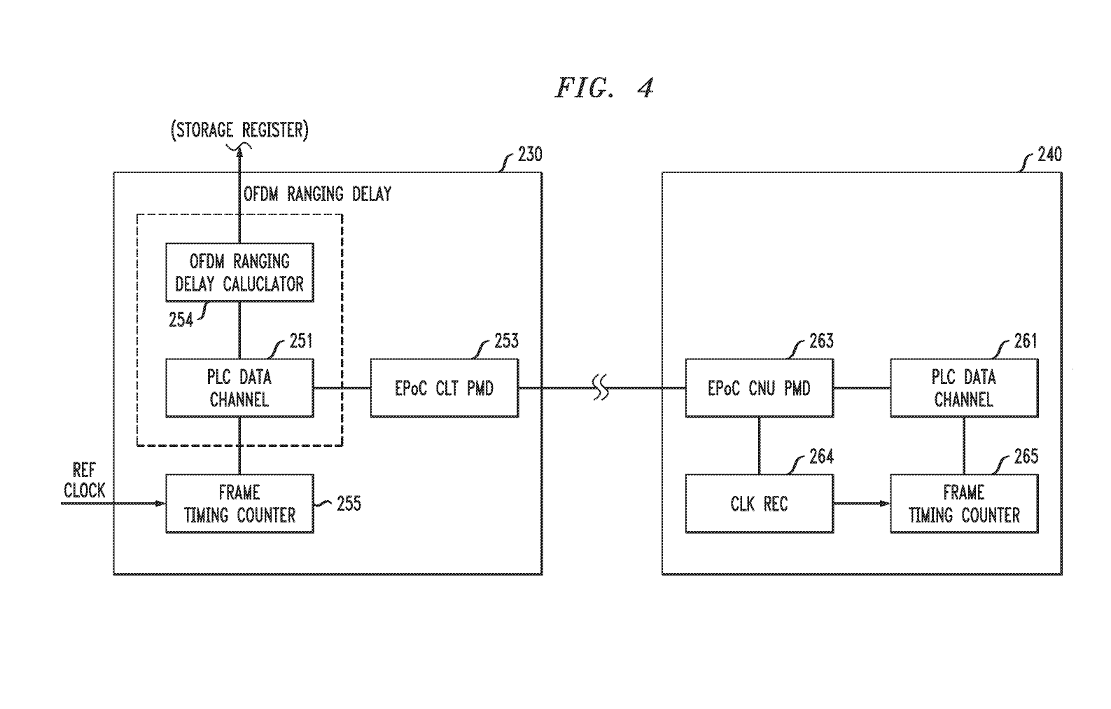

FIG. 4 is a simplified block diagram illustrating selected components of an access-network CLT and a CNU such as CLT 230 and CNU 240 shown in FIG. 3. The selected components are, generally speaking, a part of each respective node's PHY interface. The components shown are used to perform OFDM ranging. The CLT frame timing counter 255 receives a reference clock signal and transmits time-stamped frames to CNU 240 via PLC data channel 251 and EPoC CLT PMD 253.

In this embodiment, the frames from the CLT are received at CNU 240 though EPoC CNU PMD 263, where a clock recovery device 264 recovers the clock and provides a clock signal to CNU frame timing counter 265. Frame timing counter 265 also receives the frames sent by CLT via EPoC CNU PMD 263 and PLC data channel 261, and returns timing frames to CLT 230.

In this embodiment, when the frames are received at CLT 230 via EPoC CLT PMD and PLC Data Channel 251, the timestamps are extracted and OFDM Ranging Delay Calculator 254 determines the OFDM ranging delay by taking the difference between the CLT timestamp and the CNU timestamp for a particular frame. The delay value for the CNU is then stored in a storage register (not shown).

In a preferred embodiment, the CLT frame timing counter receives a 204.8 MHz reference clock signal, and the OFDM ranging delay is calculated in units of the 204.8 MHz OFDM clock. As should be apparent, this procedure is preferably repeated for each CNU that is served by the CLT, although only a single CNU is represented in FIG. 4.

In a particularly preferred embodiment, PHY transmit/receive path asymmetry is also taken into account. That is, it may be the case, especially with multiple manufacturers involved, that the downstream PHY delay does not equal the upstream PHY delay. This may affect the ToD correction calculations. Rather than try to eliminate transmit/receive path asymmetry, however, the proposed solution seeks to compensate for it.

In this embodiment, the interface delay difference for each node, for example CLT 230 and CNU 240, is defined as the difference in delay between the XGMII to the MDI path and the MDI to the XGMII path. The total transmit/receive PHY path asymmetry with respect to those two nodes is then the difference between their respective interface delay differences.

Note that FIGS. 1-4 illustrate selected components according to their respective embodiments and some variations are described above. Other variations are possible without departing from the claims of the invention as there recited. In some of these embodiments, for example, illustrated components may be integrated with each other or divided into subcomponents. There will often be additional components in the network node and in some cases fewer. The illustrations components may also perform other functions in addition to those described above, and some of the functions may alternately be performed elsewhere than described in these examples.

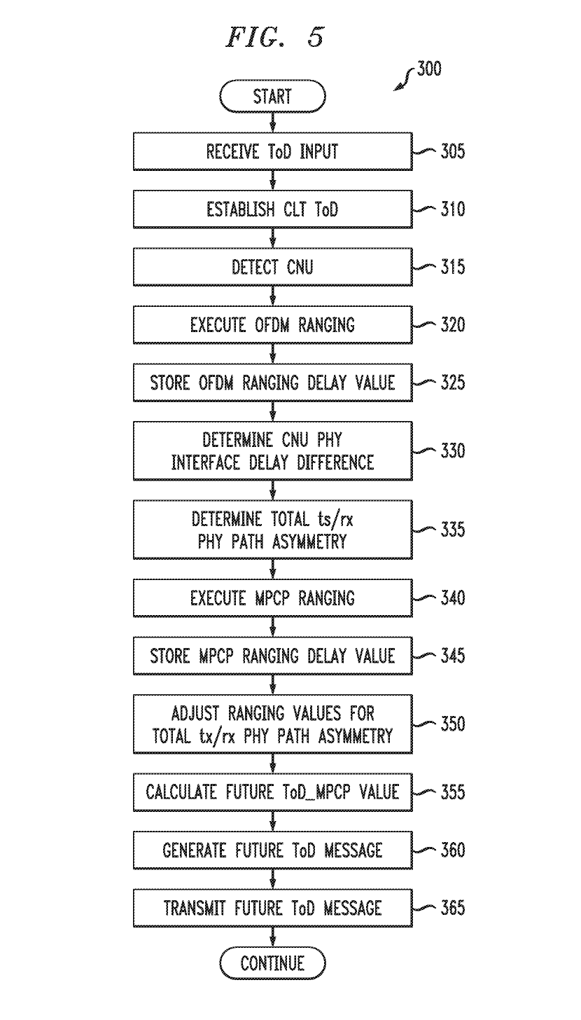

FIG. 5 is a flow diagram illustrating a method 300 according to one embodiment. At Start it is presumed that the components for performing the method are available and operational at least according to this embodiment. The process then begins with receiving (step 305) a ToD input in a CLT of an access network. The ToD value received by the CLT may in fact be received continuously or at periodic intervals. The received ToD value may be in any format, and may but does not have to be converted or adjusted for use in this process. A CLT ToD is established (step 310) based on this input. The CLT ToD is updated as new input is received. In an alternate embodiment (not shown), the ToD value may be generated in the CLT, that is, originated there, but this is not presently preferred.

In the embodiment of FIG. 5, the process continues with detecting (step 315) the presence of a CNU by a CLT. When this occurs, and perhaps periodically thereafter, the CLT executes (step 320) an OFDM ranging procedure with respect to the CNU. The OFDM ranging delay value is then stored (step 325) in a memory device. The OFDM ranging delay value may be subsequently re-determined (not shown) and, if so, the most current value is stored.

Although optional, in this embodiment the CLT also determines the PHY interface delay difference (step 330) for the CNU. This may be accomplished, for example, by query to the CNU if it is not automatically supplied during the ranging process, or by directing the CNU to make this determination and report the results. In some cases it may be inferred from other information such as the specific types of components being used by the CNU. In this embodiment, it is presumed that the PHY interface delay for the CLT is already known or may be determined (not separately shown). The process then continues with determining (step 335) the total transmit/receive PHY path asymmetry with respect to those two nodes.

Note that in an alternate embodiment (not shown), the CLT instead sends a CLT PHY interface delay difference value to the CNU and the adjustments, if any, are applied there. Such adjustments could be mandatory or optional, depending on the implementation.

In the embodiment of FIG. 5, the MPCP ranging delay with respect to the CNU is determined (step 340) and stored (step 345) in an accessible memory device. In a preferred embodiment, the total transmit/receive PHY path asymmetry is then applied (step 350) to either or both of the ranging delay values to obtain refined ranging delay value. As should be apparent, the ranging delay will be based on one-half of the RTT (round trip time) but will in this preferred embodiment be adjusted in light of the fact that future ToD messages are sent only in the downstream direction.

In the embodiment of FIG. 5, a future ToD_MPCP value is then calculated (step 355) and a future ToD message is then generated (step 360), which message contains a value for

ToD_MPCP+T_CORR

where T_CORR=T_OFDM−T_MPCP. T_OFDM and T_MPCP, in turn, are the respective ranging delay values (or adjusted ranging delay values) derived from OFDM and MPCP ranging calculations. Note that although shown as two steps, calculating the future ToD and generating the message including the correction may be done as one (or several) operations, and the value included in the message may be either a single corrected value or values for both ToD_MPCP and T_CORR. The future ToD message is then transmitted (step 365) to the CNU. The process then continues for other CNUs, if any, and for subsequent re-synchronization, if desired.

Note that FIG. 5 and the description above relate to the process for a single CNU. This process is preferable applied for all CNUs connected to the CLT. In addition, the process for some or all of the CNUs is preferably repeated from time to time to account for possible changes in conditions or environment, and hence different values for the ranging delay and corrections. Note also that when the method 300 is described in an EPoC environment, it may be equally applicable in other environments as well, for example a PON or data center.

Note that the sequence of operation illustrated in FIG. 5 represents an exemplary embodiment; some variation is possible within the spirit of the invention. For example, additional operations may be added to those shown in FIG. 5, and in some implementations one or more of the illustrated operations may be omitted. In addition, the operations of the method may be performed in any logically-consistent order unless a definite sequence is recited in a particular embodiment.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors. The executable instructions may, if explicitly recited in a particular embodiment, also be embodied in a propagating signal.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

What is claimed is:

1. A method of facilitating synchronization of nodes in a communication network, comprising:
performing OFDM ranging by a first node to determine an OFDM ranging delay value for transmissions between the first node and a second node;
receiving a ToD value at the first node; and
calculating by the first node a future ToD value for the second node based on at least the received ToD value and a ToD correction value based at least on the determined OFDM ranging delay value.

2. The method of claim 1, further comprising generating a future ToD message based at least in part on the future ToD value and the ToD correction value.

3. The method of claim 2, further comprising transmitting the future ToD message toward the second node.

4. The method of claim 2, wherein the future ToD message comprises the calculated future ToD value and the ToD correction value.

5. The method of claim 2, wherein the future ToD message comprises a corrected future ToD value.

6. The method of claim 1, further comprising determining an MPCP ranging delay value for transmissions between the first node and the second node.

7. The method of claim 6, further comprising storing the MPCP ranging delay value in a memory device.

8. The method of claim 6, wherein the ToD correction value is based at least in part on the MPCP ranging delay value.

9. The method of claim 8, wherein the ToD correction value is based at least in part on the difference between the MPCP ranging delay value and the OFDM ranging delay value.

10. The method of claim 1, further comprising determining a total transmit/receive PHY path asymmetry value with respect to the first node and the second node.

11. The method of claim 10, further comprising adjusting the OFDM ranging delay value based at least in part on the total transmit/receive PHY path asymmetry value.

12. The method of claim 1, further comprising transmitting toward the second node a PHY interface delay difference value for the first node.

13. The method of claim 1, further comprising storing the OFDM ranging delay value in a memory device.

14. The method of claim 1, wherein the first node is a CLT in an access network.

15. The method of claim 1, wherein the second node is a CNU in an access network.

16. The method of claim 1, detecting the second node by the first node.

17. A machine-readable storage medium embodying program instructions that when executed by one or more processors cause a first network node to:
perform OFDM ranging to determine an OFDM ranging delay value for transmissions between the first node and a second node;
receive a ToD value at the first node; and
calculating by the first node a future ToD value for the second node based on at least the received ToD value and a ToD correction value based at least on the determined OFDM ranging delay value.

18. The machine-readable storage medium of claim 17, wherein the program instructions when executed further cause the network node to generate a future ToD message based at least in part on the future ToD value and the ToD correction value.

19. The machine-readable storage medium of claim 17, wherein the program instructions when executed further cause the network node to determine an MPCP ranging delay value for transmissions between the first node and the second node, and wherein the ToD correction value is based at least in part on the MPCP ranging delay value.

20. The machine-readable storage medium of claim 17, wherein the program instructions when executed further cause the network node to determine a total transmit/receive PHY path asymmetry value with respect to the first node and the second node and to adjust the OFDM ranging value based at least in part on the total transmit/receive PHY path asymmetry value.
